(19) United States
(12) Patent Application Publication
(10) Pub. No.: US 2023/0420795 A1
(43) Pub. Date: Dec. 28, 2023

(54) BATTERY PACK WITH SACRIFICIAL CELL VENT

(71) Applicant: GM GLOBAL TECHNOLOGY OPERATIONS LLC, Detroit, MI (US)

(72) Inventors: Ryan P. Hickey, Austin, TX (US); Liang Xi, Northville, MI (US)

(73) Assignee: GM GLOBAL TECHNOLOGY OPERATIONS LLC, Detroit, MI (US)

(21) Appl. No.: 17/847,807

(22) Filed: Jun. 23, 2022

(51) Int. Cl. H01M 50/375; H01M 50/342; H01M 50/204; H01M 50/278

(52) U.S. Cl. CPC H01M 50/375; H01M 50/342; H01M 50/204; H01M 50/278

(57) ABSTRACT

A battery pack includes battery cells arranged a distance above a battery tray such that an exhaust passage is defined between the battery cells and the battery tray. Each respective one of the battery cells includes a casing defining a cell cavity therein and having an end surface disposed proximate the battery tray, an anode and a cathode disposed within the cell cavity, and a sacrificial vent cap. The sacrificial vent cap is constructed at least partially of a polymeric material and connected to the end surface of the casing. The sacrificial vent cap is configured to melt or fracture at a predetermined temperature or pressure, respectively, to thereby connect the cell cavity to the exhaust passage.

### INTRODUCTION

Electrochemical battery packs are used in a host of battery electric systems. Aboard an electric vehicle in particular, a high-energy propulsion battery pack is arranged on a direct current (DC) voltage bus, with the propulsion battery pack having an application-suitable number of cylindrical, prismatic, or pouch-style electrochemical battery cells. The DC voltage bus ultimately powers one or more electric traction motors and associated power electronic components during battery discharging modes. The same DC voltage bus conducts a charging current to constituent battery cells of the battery pack during battery charging modes.

Propulsion battery packs for use with electric vehicles and other battery electric systems typically utilize a lithium-based or nickel-based battery chemistry. In lithium-ion battery cells, for instance, the movement of electrons and lithium ions produces electricity for use in powering the above-noted electric traction motor(s). Charging and discharging of the battery cells is accompanied by a discharge of heat. The generated heat in turn must be dissipated from the battery cells, e.g., via circulation of battery coolant, cooling plates, or cooling fins. Under rare conditions, battery cell damage, age, or degradation could lead to the generation of heat in a battery cell or battery pack at a rate exceeding an existing cooling capability. Such a condition is referred to both herein and in the art as thermal runaway.

### SUMMARY

Disclosed herein is an electrochemical battery pack with a plurality of battery cells. Each respective one of the battery cells has a corresponding vent opening (“cell vent”) that opens to release hot vent gasses from the battery cell during thermal runaway. Unlike a typical cell vent which ejects a disc-shaped vent cover onto a battery tray situated below a level of the battery cell, thus requiring the battery pack to have a greater height/z-dimension in a typical “xyz” Cartesian reference frame, the disclosed cell vent is instead configured to melt or disintegrate when a cell temperature or pressure exceeds a corresponding threshold. Likewise, a final orientation of an ejected vent cap in a traditional vent cap construction is unpredictable, as uneven pressure in a casing of the battery cell may cause the vent cap to partially open. At least some of the attendant benefits of the present construction therefore include a corresponding reduction in the above-noted z-dimension and the elimination of vent cap positional uncertainty. As a result, the hardware solutions described below allow for z-height spacing considerations in a battery pack to be driven by vent gas flow considerations as opposed to vent cap ejection trajectories.

As appreciated by those skilled in the art, propulsion battery packs of battery electric vehicles and other electrified powertrain systems typically include a battery cover or housing equipped with several perimeter vents. A vent membrane disposed within such perimeter vents is configured to burst open when the battery pack's internal pressure exceeds a particular value, e.g., about 20-25 kilopascals (kPa). Failure of the membrane in this manner allows hot vent gasses captive within the housing to be exhausted to the surrounding ambient. Each respective one of the battery cells may be equipped with one of the above-noted cell vents. Thus, pack-level venting via the perimeter vents may occur in conjunction with the cell-level venting of the present disclosure, with the present teachings not otherwise affecting the structure of performance of such perimeter vents.

In particular, an aspect of the present disclosure includes a battery pack having a battery tray and a plurality of battery cells. The battery cells are arranged at a distance or height above the battery tray such that an exhaust passage is defined between the battery cells and the battery tray. Each respective battery cell may include a casing defining a cell cavity therein, and having an end surface disposed proximate the battery tray, an anode and a cathode disposed within the cell cavity, and a sacrificial vent cap. Each sacrificial vent cap is constructed at least partially of a polymeric material and is connected to the end surface of the casing. The sacrificial vent cap is configured to melt or disintegrate at a predetermined temperature or pressure, respectively, to thereby connect the cell cavity to the exhaust passage.

The sacrificial vent cap in one or more embodiments may be constructed entirely of the polymeric material. The sacrificial vent cap in other embodiments may include an outer ring of metal or another temperature resistant material defining a vent opening, with the polymeric material filling and closing off the vent opening.

The sacrificial vent cap may include a spark arresting layer defining through-holes and spanning the vent opening. In such an embodiment, the spark arresting layer may include a metallic mesh disposed within the vent opening and in contact with the polymeric material. The metallic mesh may be constructed of steel or aluminum in different non-limiting exemplary embodiments.

The polymeric material may be optionally constructed of a potting compound. In such a construction, the sacrificial vent cap may include a metallic mesh disposed within the vent opening in contact with the potting compound.

The distance of the battery cells above the battery tray is less than about 10 millimeters (mm) in a possible embodiment, e.g., between about 5 mm and 10 mm.

Also disclosed herein is a battery cell for use with a battery pack having a battery tray and an exhaust passage. The battery cell in a possible embodiment includes a casing defining a cell cavity therein and having an end surface, an anode and a cathode disposed within the cell cavity, and a sacrificial vent cap. The sacrificial vent cap is constructed at least partially of a polymeric material and connected to the end surface of the casing. The sacrificial vent cap is configured to melt or disintegrate at a predetermined temperature or pressure, respectively, to thereby connect the cell cavity to the exhaust passage.

Another aspect of the disclosure includes an electrified powertrain system, a representative embodiment of which includes a rotary electric machine connected to a load and a battery pack connected to the rotary electric machine. The battery pack may include a battery tray and battery cells arranged a distance above the battery tray, such that an exhaust passage is defined between the battery cells and the battery tray. Each respective one of the battery cells in this embodiment includes a casing defining a cell cavity therein and having an end surface disposed proximate the battery tray, an anode and a cathode disposed within the cell cavity, and a sacrificial vent cap. The sacrificial vent cap, which is constructed at least partially of a polymeric material and is connected to the end surface of the casing, and includes a spark arresting layer. The spark arresting layer defines a plurality of through-holes. The sacrificial vent cap in this representative construction includes an outer metal ring defining a vent opening filled with the polymeric material. The polymeric material is configured to melt or disintegrate at a predetermined temperature or pressure, respectively, to thereby connect the cell cavity to the exhaust passage.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an exemplary electrified powertrain system equipped with a battery pack having cell vents equipped with sacrificial vent caps in accordance with the disclosure.

FIG. 2 is a plan view illustration of a representative embodiment of the battery pack shown in FIG. 1.

FIG. 3 is perspective view illustration of a sacrificial vent cap usable with the battery pack of FIG. 2.

FIG. 4 is a side view illustration of a cell vent, vent cap, and battery tray depicting a representative z-dimension of the battery pack.

FIG. 5 is a plan view illustration of a sacrificial vent cap in accordance with an aspect of the disclosure.

FIG. 6 is a side view illustration of the sacrificial vent cap of FIG. 5.

FIG. 7 is a plan view illustration of a sacrificial vent cap in accordance with another aspect of the disclosure.

FIG. 8 is a side view illustration of the sacrificial vent cap of FIG. 7.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

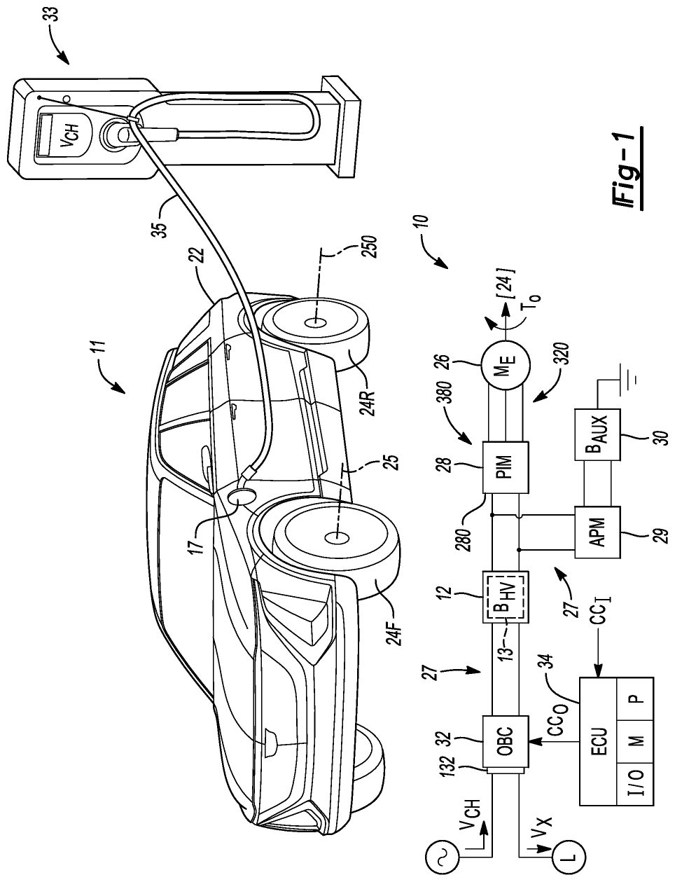

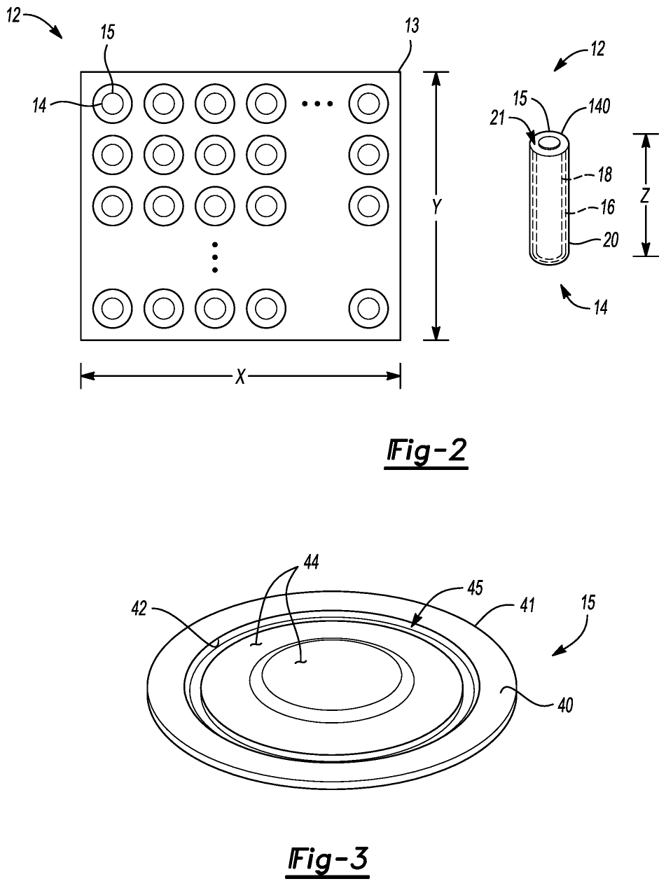

Referring to the drawings, wherein like reference numbers refer to like features throughout the several views, FIG. 1 depicts an electrified powertrain system 10 having a high-voltage battery pack (B_{HV}) 12. In a non-limiting example, the battery pack 12 may be embodied as a high-capacity battery having a voltage capability of about 400-800 volts or more, with the actual voltage capability of the battery pack 12 provided based on a desired operating range, gross weight, and power rating of a load connected to the battery pack 12. In a possible construction, the battery pack 12 may be a propulsion battery pack generally composed of an array of lithium-ion or lithium-ion polymer rechargeable electrochemical battery cells, exemplified herein as a cylindrical battery cell 14 as best shown in FIG. 2. The present teachings may also be applied to prismatic battery cells, and possibly to pouch-style battery cells in possible configurations, and thus the cylindrical battery cell 14 is exemplary without being limiting.

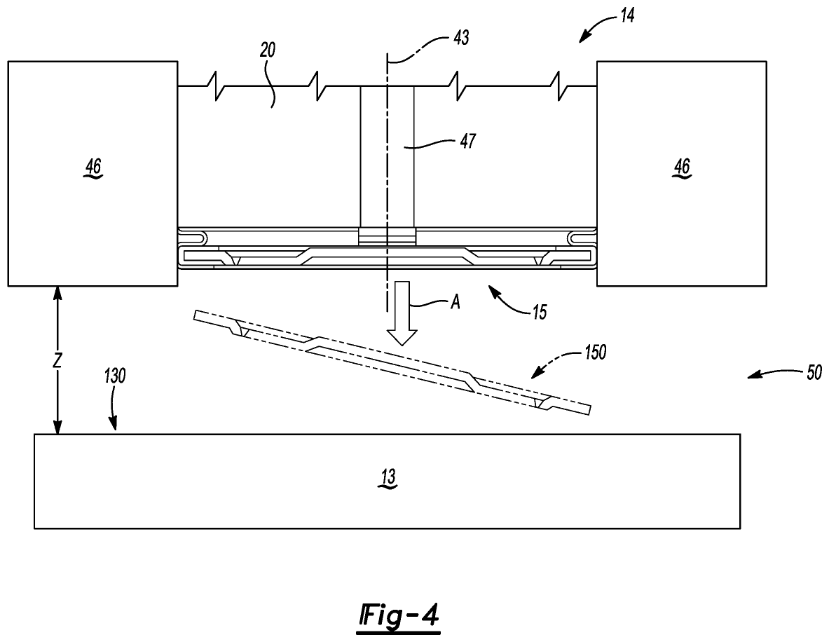

Referring briefly to FIG. 2, the battery pack 12 of FIG. 1 includes a battery tray 13 positioned with respect to a plurality of the cylindrical battery cells 14. Within the scope of the present disclosure, each respective one of the battery cells 14 includes a sacrificial vent cap 15 operable for releasing hot gasses from the battery cell 14 to an exhaust passage 50 (FIG. 4) of the battery pack 12 during a thermal runaway condition. Each battery cell 14 includes an outer can or casing 20 defining a cell cavity 21 therein and having an end surface 140.

Although internal details of the battery cells 14 are omitted for illustrative simplicity, those skilled in the art will appreciate that the battery cells 14 contain within the cell cavity 21 an electrolyte material, working electrodes in the form of a cathode 16 and an anode 18, and a permeable separator (not shown), which are collectively enclosed inside an electrically-insulated can or casing 20. Grouped battery cells 14 may be connected in series or parallel through use of an electrical interconnect board and related buses, sensing hardware, and power electronics (not shown but well understood in the art). An application-specific number of the battery cells 14 of FIG. 2 may be arranged relative to the battery tray 13 in columns and rows as shown. In a nominal “xyz” Cartesian reference frame, for instance, the battery tray 13 when viewed from above or below may have a length (x-dimension) and a width (y-direction), with a height (z-dimension) extending in an orthogonal direction away from the battery tray 13.

Optional embodiments for constructing the sacrificial vent caps 15 of FIG. 2 are set forth in detail below with particular reference to FIGS. 4-8, with the sacrificial vent caps 15 being configured to melt or disintegrate at a predetermined temperature or pressure, respectively, to thereby connect the cell cavity 21 to the exhaust passage 50 of FIG. 4 of the battery pack 12. Thus, elevated temperature or pressures within a given battery cell 14 are locally treated by the rapid destruction of the sacrificial vent cap 15, which in turn eliminates the need for vent cap ejection and the additional z-dimension and problems associated therewith.

Referring again to FIG. 1, in a representative use case the electrified powertrain system 10 may be used as part of a motor vehicle 11 or another mobile system. As shown, the motor vehicle 11 may be embodied as a battery electric vehicle, with the present teachings also being extendable to plug-in hybrid electric vehicles. Alternatively, the electrified powertrain system 10 may be used as part of another mobile system such as but not limited to a rail vehicle, aircraft, marine vessel, robot, farm equipment, etc. Likewise, the electrified powertrain system 10 may be stationary, such as in the case of a powerplant, hoist, drive belt, or conveyor system. Therefore, the electrified powertrain system 10 in the representative vehicular embodiment of FIG. 1 is intended to be illustrative of the present teachings and not limiting thereof.

The motor vehicle 11 shown in FIG. 1 includes a vehicle body 22 and road wheels 24F and 24R, with “F” and “R” indicating the respective front and rear positions. The road wheels 24F and 24R rotate about respective axes 25 and 250, with the road wheels 24F, the road wheels 24R, or both being powered by output torque (arrow To) from a rotary electric machine (M_{E}) 26 of the electrified powertrain system 10 as indicated by arrow [24]. The road wheels 24F and 24R thus represent a mechanical load in this embodiment, with other possible mechanical loads being possible in different host systems. To that end, the electrified powertrain system 10 includes a power inverter module (PIM) 28 and the high-voltage battery pack 12, e.g., a multi-cell lithium-ion propulsion battery or a battery having another application-suitable chemistry, both of which are arranged on a high-voltage DC bus 27. As appreciated in the art, the PIM 28 includes a DC side 280 and an alternating current (AC) side 380, with the latter being connected to individual phase windings (not shown) of the rotary electric machine 26 when the rotary electric machine 26 is configured as a polyphase rotary electric machine in the form of a propulsion or traction motor as shown.

The battery pack 12 of FIG. 1 in turn is connected to the DC side 280 of the PIM 28, such that a battery voltage from the battery pack 12 is provided to the PIM 28 during propulsion modes of the motor vehicle 11. The PIM 28, or more precisely a set of semiconductor switches (not shown) residing therein, are controlled via pulse width modulation, pulse density modulation, or other suitable switching control techniques to invert a DC input voltage on the DC bus 27 into an AC output voltage suitable for energizing a high-voltage AC bus 320. High-speed switching of the resident semiconductor switches of the PIM 28 thus ultimately energizes the rotary electric machine 26 to thereby cause the rotary electric machine 26 to deliver the output torque (arrow To) as a motor drive torque to one or more of the road wheels 24F and/or 24R in the illustrated embodiment of FIG. 1, or to another coupled mechanical load in other implementations.

Electrical components of the electrified powertrain system 10 may also include an accessory power module (APM) 29 and an auxiliary battery (B_{AUX}) 30. The APM 29 is configured as a DC-DC converter that is connected to the DC bus 27, as appreciated in the art. In operation, the APM 29 is capable, via internal switching and voltage transformation, of reducing a voltage level on the DC bus 27 to a lower level suitable for charging the auxiliary battery 30 and/or supplying low-voltage power to one or more accessories (not shown) such as lights, displays, etc. Thus, “high-voltage” refers to voltage levels well in excess of typical 12-15V low/auxiliary voltage levels, with 400V or more being an exemplary high-voltage level in some embodiments of the battery pack 12.

In some configurations, the electrified powertrain system 10 of FIG. 1 may include an on-board charger (OBC) 32 that is selectively connectable to an offboard charging station 33 via an input/output (I/O) block 132 during a charging mode during which the battery pack 12 is recharged by an AC charging voltage (V_{CH}) from the offboard charging station 33. The I/O block 132 is connectable to a charging port 17 on the vehicle body 22. For instance, a charging cable 35 may be connected to the charging port 17, e.g., via an SAE J1772 connection. The electrified powertrain system 10 may also be configured to selectively receive a DC charging voltage in one or more embodiments as appreciated in the art, in which case the OBC 32 would be selectively bypassed using circuitry (not shown) that is not otherwise germane to the present disclosure. The OBC 32 could operate in different modes, including a charging mode during which the OBC 32 receives the AC charging voltage (V_{CH}) from the offboard charging station 33 to recharge the battery pack 12, and a discharging mode, represented by arrow V_{X}, during which the OBC 32 offloads power from the battery pack 12 to an external AC electrical load (L). In this manner, the OBC 32 may embody a bidirectional charger.

Still referring to FIG. 1, the electrified powertrain system 10 may also include an electronic control unit (ECU) 34. The ECU 34 is operable for regulating ongoing operation of the electrified powertrain system 10 via transmission of electronic control signals (arrow CC_{O}). The ECU 34 does so in response to electronic input signals (arrow CC_{I}). Such input signals (arrow CC_{I}) may be actively communicated or passively detected in different embodiments, such that the ECU 34 is operable for determining a particular mode of operation. In response, the ECU 34 controls operation of the electrified powertrain system 10.

To that end, the ECU 34 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The ECU 34 also includes an associated computer-readable storage medium, i.e., memory (M) inclusive of read only, programmable read only, random access, a hard drive, etc., whether resident, remote or a combination of both. Control routines are executed by the processor to monitor relevant inputs from sensing devices and other networked control modules (not shown), and to execute control and diagnostic routines to govern operation of the electrified powertrain system 10.

Referring briefly to FIG. 3, the battery pack 12 of FIG. 1 is constructed from a plurality of the cylindrical battery cells 14 of FIG. 2 in a representative non-limiting configuration, as described generally hereinabove. Each respective one of the cylindrical battery cells 14 is equipped with a corresponding one of the sacrificial vent caps 15. In a possible embodiment, the sacrificial vent cap 15 has an outer perimeter 41 that is circular, such that the sacrificial vent cap 15 is disc-shaped. The sacrificial vent cap 15 may include an outer ring 40 having the outer perimeter 41 as an outer diameter surface, and an inner perimeter 42 forming an inner diameter surface. A sacrificial barrier 44 configured to melt or disintegrate as set forth below is connected to or formed integrally with the outer ring 40. Thus, when the sacrificial barrier 44 melts, fractures, disintegrates, or otherwise irreversibly fails, a circular vent opening 45 is formed in the cylindrical battery cell 14 of FIG. 2 to allow hot vent gasses to quickly escape from the cell cavity 21.

Referring to FIG. 4, the above-noted battery tray 13 shown schematically in FIG. 1 is disposed below a representative battery cell 14, a portion of which is shown schematically for illustrative simplicity and clarity. The battery cell 14 may be connected to a cell holder 46, e.g., a fixture operable for spacing and orienting multiple battery cells 14 at a predetermine height (z-dimension) above the battery tray 13. The present sacrificial vent cap 15, which in a possible embodiment may be constructed entirely of a polymeric material, is arranged concentrically with a longitudinal center axis 43 of the battery cell 14, with the longitudinal center axis 43 being coaxial with a center rod 47 of the battery cell 14.

As shown in phantom, a traditional vent cap 150 constructed of a flat disc of sheet metal typically separates and ejects (arrow A) toward a surface 130 of the battery tray 13 in response to a threshold high pressure level within a battery cell, such as the representative battery cell 14 of FIG. 4. For example, material surrounding an outer perimeter of the cell vent may be left relatively thin such that elevated cell pressures cause the cell vent to tear away from the casing at the thinned sections. When the traditional vent cap 150 is successfully ejected in this manner, hot vent gasses inside of the battery cell 14 enter the exhaust passage 50 and flow out from the battery pack 12 via the above-summarized perimeter vents (not shown).

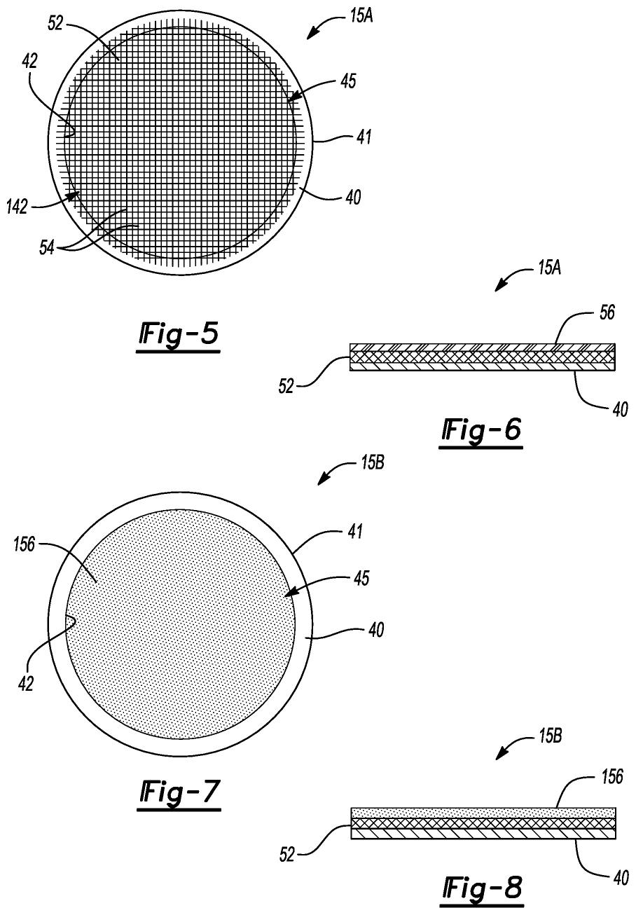

As indicated by the orientation of the representative traditional vent cap 150 of FIG. 4, however, ejection requires a greater z-dimension, typically at least 20 mm, which results in a taller battery pack 12. The unpredictable nature of the ejection trajectory may also lead at times to partial separation of the traditional vent cap 150 from the casing 20, sometimes leaving the traditional vent cap 150 partially attached. A canted vent cap 150 could impede the flow of vent gasses from the battery cell 14 through the exhaust passage 50. The present solutions are therefore intended to improve upon the current state of the art of cell-level venting using the sacrificial vent cap 15, exemplary constructions of which will now be described with reference to FIGS. 5-8.

Referring to FIGS. 5 and 6, the sacrificial vent cap 15A in a possible construction includes the outer ring 40, e.g., a ring of stainless or carbon steel or another application-suitable metal, with the outer ring 40 defining the vent opening 45 as noted above with reference to FIG. 3. As shown in the side view illustration of FIG. 6, polymeric material 56 may be used to fill and close off the vent opening 45 of FIG. 5 to retain an electrolyte material (not shown) within the casing 20 of FIG. 2. Under thermal runaway conditions, this polymeric material 56 will quickly melt, thus allowing vent gasses to escape to the exhaust passage 50 of FIG. 4. The illustrated embodiment of FIGS. 5 and 6 includes an optional spark arresting layer 52 defining a plurality of through-holes 54 and spanning the vent opening 45. For instance, the spark arresting layer 52 may include a metallic mesh 142 disposed within the vent opening 45 in contact with the polymeric material 56. The size and distribution of the through-holes 54 in the spark arresting layer 52 may be selected to block a desired particle size, and thus to “tune” spark arresting and venting performance.

As temperatures within the battery cell 14 during thermal runaway quickly increase well beyond the melting points of most commercially available polymers, the sacrificial vent cap is expected to melt, thereby uncovering the vent opening 45 almost instantaneously in the presence of vent gasses, which may reach temperatures of at least 1000° C. within the battery cell 14. By way of example, the polymeric material 56 of FIG. 6 may include one or more of polytetrafluoroethylene (PTFE), nylon, polyethylene, polyamide, acrylic, polyetheretherketone (PEEK), polypropylene, thermoplastic, etc. When the polymeric material 56 melts, the through-holes 54 are left open, which in turn would allow particulate and molten materials within the cell cavity 21 of FIG. 2 to be arrested while allowing vent gasses to escape into the exhaust passage 50 of FIG. 4.

In some implementations, the metallic mesh 142 may be constructed of steel, e.g., carbon steel or stainless steel. As such materials have a melting point of at least 1400° C., i.e., well in excess of the polymeric material 56, the metallic mesh 142 remains intact through the duration of thermal runaway. In another construction, the metallic mesh 142 may have a lower melting point. For example, the metallic mesh 142 may be constructed of aluminum having a melting point of about 660° C., which would result in melting of the metallic mesh 142, e.g., to release accumulated particulate or molten matter onto the battery tray 13 of FIG. 4 and away from neighboring battery cells 14. Other materials may be selected for constructing the metallic mesh 142 to provide a desired temperature “setpoint” for a given sacrificial cell vent, and therefore the particular example constructions specified herein are illustrative of the present teachings and non-limiting.

Referring to FIGS. 7 and 8, in another embodiment a sacrificial vent cap 15B includes a polymeric material 156 in the form of a frangible potting compound disposed within the vent opening 45 of the outer ring 40. Exemplary potting compounds usable within the scope of the disclosure include but are not limited to silicone-based materials, polyurethane, etc. The potting material in such an embodiment fills and closes off the vent opening 45, with the outer ring 40 providing perimeter structural support to the potting material. The sacrificial vent cap 15B may optionally include the above-described metallic mesh 142 in such embodiments, which may be disposed within the vent opening 45 of FIG. 7 in contact with the polymeric material 156, i.e., the frangible potting compound. Thus, the embodiment of FIGS. 7 and 8 could be used with or without the metallic mesh 142 in different constructions.

As appreciated in the art, manufacturing of the battery pack 12 of FIG. 1 may include depositing of potting material at or near a cell vent interface for the purpose of thermal runaway protection. The present approach would combine the sacrificial vent cap 15B and potting material into a single component to simplify assembly of the battery cells 14 into the battery pack 12 or a module thereof. For instance, during assembly of the battery cells 14, each battery cell 14 could be dipped into a liquid potting material and cured.

The sacrificial vent caps 15 described above are configured to fail at much lower pressure and/or temperatures relative to traditional rigid metal vent caps, exemplified as vent cap 150 in FIG. 4. Melting or other failure of the sacrificial vent caps 15 ensure that the sacrificial vent cap 15 does not become an obstruction within the battery pack 12 of FIG. 1 for the remainder of the thermal runway event. The temperature or pressure-based melting or disintegration of the sacrificial vent cap 15 in turn results in less packaging space to ensure proper venting of the battery cell 14, with the corresponding reduction in the height of the battery pack 12. When used aboard the representative motor vehicle 11 of FIG. 1, the result is a lower ride height and improved drive performance. These and other attendant benefits will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

1. A battery pack comprising:
a battery tray;
a plurality of battery cells arranged a distance above the battery tray such that an exhaust passage is defined between the plurality of battery cells and the battery tray, wherein each respective one of the battery cells comprises:
a casing defining a cell cavity therein and having an end surface disposed proximate the battery tray;
an anode and a cathode disposed within the cell cavity; and
a sacrificial vent cap constructed at least partially of a polymeric material and connected to the end surface of the casing, wherein the sacrificial vent cap is configured as a sacrificial barrier to close off the cell cavity from the exhaust passage and retain an electrolyte material therein when an internal temperature of the cell cavity fails to exceed a predefined temperature, wherein the sacrificial vent cap is configured to irreversibly melt when the internal temperature exceeds the predetermined temperature such that the cell cavity opens up through the sacrificial vent cap to the exhaust passage to permit cell cavity gasses within the cell cavity to escape out through the sacrificial vent cap into the exhaust passage.

2. The battery pack of claim 1, wherein the sacrificial vent cap is constructed entirely of the polymeric material and wherein the sacrificial vent cap is configured to melt without the polymeric material falling into or becoming an obstruction within the exhaust passage.

3. The battery pack of claim 1, wherein the sacrificial vent cap is disc-shaped and includes an outer ring defining a vent opening, and wherein the polymeric material fills and closes off the vent opening.

4. The battery pack of claim 3, wherein the sacrificial vent cap includes a spark arresting layer defining a plurality of through-holes and spanning the vent opening.

5. The battery pack of claim 4, wherein the spark arresting layer includes a metallic mesh disposed within the vent opening in contact with the polymeric material and wherein the metallic mesh is configured to be retained within the vent opening upon the sacrificial vent cap melting such that the metallic mesh allows particulate and molten materials within the cell cavity to be arrested and retained within the cell cavity while contemporaneously allowing the cell cavity gasses to escape from the cell cavity into the exhaust passage.

6. The battery pack of claim 5, wherein the metallic mesh is constructed of steel having a higher melting temperature than the polymeric material.

7. The battery pack of claim 5, wherein the metallic mesh is constructed of aluminum having a higher melting temperature than the polymeric material.

8. The battery pack of claim 1, wherein the polymeric material includes a frangible potting compound configured to irreversibly fracture at a predetermined pressure while the internal temperature is below the predefined temperature such that upon fracturing the cell cavity opens up through the sacrificial vent cap to permit the cell cavity gasses to escape out into the exhaust passage.

9. The battery pack of claim 8, wherein the sacrificial vent cap includes a metallic mesh disposed within the vent opening in contact with the frangible potting compound.

10. The battery pack of claim 2, wherein the distance above the battery tray is less than about 10 millimeters, the distance approximating a z-dimension height of the exhaust passage.

11. A battery cell for use with a battery pack having a battery tray and an exhaust passage, the battery cell comprising:
a casing defining a cell cavity therein and having an end surface;
an anode and a cathode disposed within the cell cavity; and
a sacrificial vent cap constructed at least partially of a polymeric material and connected to the end surface of the casing to close off the cell cavity from the exhaust passage, wherein the sacrificial vent cap is configured to melt at a predetermined temperature to thereby open up and connect the cell cavity to the exhaust passage without obstructing the exhaust passage with the polymeric material.

12. The battery cell of claim 11, wherein the sacrificial vent cap is constructed entirely of the polymeric material and is arranged concentrically with a longitudinal center axis of the battery cell, with the longitudinal center axis being coaxial with a center rod of the battery cell.

13. The battery cell of claim 11, wherein the sacrificial vent cap is disc-shaped and includes an outer ring defining a vent opening, and wherein the polymeric material fills and closes off the vent opening.

14. The battery cell of claim 13, wherein the sacrificial vent cap includes a spark arresting layer defining a plurality of through-holes configured to retain a molten material within the cell cavity.

15. The battery cell of claim 14, wherein the spark arresting layer includes a metallic mesh disposed within the vent opening in contact with the polymeric material and wherein the spark arresting layer is configured to be retained within the vent opening upon the sacrificial vent cap melting to allow particulate and molten materials within the cell cavity to be arrested and retained within the cell cavity by the through-holes while contemporaneously allowing the cell cavity gasses to escape from the cell cavity into the exhaust passage.

16. The battery cell of claim 15, wherein the metallic mesh is constructed of steel having a higher melting temperature than the polymeric material.

17. The battery cell of claim 15, wherein the metallic mesh is constructed of aluminum having a higher melting temperature than the polymeric material.

18. The battery cell of claim 13, wherein the polymeric material includes a frangible potting compound, and wherein the sacrificial vent cap is configured to fracture at a predetermined pressure to thereby connect the cell cavity to the exhaust passage, upon fracturing of the sacrificial vent cap when an internal pressure of the cell cavity equals or exceeds the predetermined pressure, such that the cell cavity is connected to the exhaust passage without the sacrificial vent cap obstructing, the exhaust passage while allowing gasses within the cell cavity to escape into the exhaust passage.

19. An electrified powertrain system for a vehicle having a plurality of road wheels, comprising:
a rotary electric machine configured to deliver output torque to the road wheels; and
a battery pack connected to the rotary electric machine, the battery pack comprising:
a battery tray;
a cell holder disposed above the battery tray; and
a plurality of battery cells connected to the cell holder operable for spacing and orienting the plurality of battery cells at a distance above the battery tray, the plurality of battery cells arranged the distance above the battery tray such that an exhaust passage is defined between the plurality of battery cells and the battery tray, wherein each respective one of the battery cells comprises:
a casing defining a cell cavity therein and having an end surface disposed proximate the battery tray;
an anode and a cathode disposed within the cell cavity; and
a sacrificial vent cap constructed at least partially of a polymeric material, connected to the end surface of the casing, and including a spark arresting layer includes a mesh having a plurality of through-holes, wherein the sacrificial vent cap includes an outer ring defining a vent opening filled with the polymeric material, and wherein the polymeric material is configured to melt at a first predetermined temperature to thereby connect the cell cavity to the exhaust passage such that the cell cavity is connected to the exhaust passage without the polymeric material obstructing the exhaust passage, and wherein the mesh is configured to melt at a second predetermined temperature greater than the first predetermined temperature such that the mesh remains intact upon the polymeric material melting to thereafter arrest particular and molten materials within the cell cavity before obstructing the exhaust passage while contemporaneously allowing gasses within the cell cavity to escape into the exhaust passage.

20. The electrified powertrain system of claim 19, wherein the electrified powertrain system is used aboard a motor vehicle, the battery pack is a propulsion battery pack, and the distance above the battery tray is less than about 6 millimeters.
